(19) United States
(12) Patent Application Publication
(10) Pub. No.: US 2014/0184416 A1
(43) Pub. Date: Jul. 3, 2014

(54) MONITORING SYSTEM

(71) Applicants: HON HAI PRECISION INDUSTRY CO., LTD., New Taipei (TW); HONG FU JIN PRECISION INDUSTRY (Shenzhen) CO., LTD, Shenzhen (CN)

(72) Inventor: MENG-LIANG YANG, Shenzhen (CN)

(73) Assignees: HON HAI PRECISION INDUSTRY CO., LTD., New Taipei (TW); HONG FU JIN PRECISION INDUSTRY (Shenzhen) CO., LTD, Shenzhen (CN)

(21) Appl. No.: 14/134,255

(22) Filed: Dec. 19, 2013

(30) Foreign Application Priority Data
Dec. 29, 2012 (CN) 2012105892862

(51) Int. Cl. G08B 21/18

(52) U.S. Cl. CPC G08B 21/18
USPC 340/686.1

(57) ABSTRACT

A monitoring system includes a reflection device, a light source, a receiver, a light conversion device, a processor, and an indication unit. The reflection device is located on an inner surface of a cover, and the light source and the receiver are located on a shell. When the cover covers the shell, light emitted from the light source can reach the reflection device and be reflected onto the receiver. When the cover is open, light emitted from the light source cannot reach the reflection device and is not reflected onto the receiver. The light conversion device converts light received by the receiver into electrical signals. The processor receives the electrical signals and outputs a control signal to the indication unit when the electrical signals are not received. The indication unit is connected to the processor and indicates that the cover is open upon receiving the control signal.

### BACKGROUND

1. Technical Field

The present disclosure relates to a monitoring system for a case of an electronic device.

2. Description of Related Art

When servers are opened, notification systems called “intruders” are used to inform a user that the server is opened. The intruder is also used to record information about the servers in an opened state. However, the intruder is mechanical and may become insensitive after being used for a period of time.

Therefore, there is room for improvement in the art.

### BRIEF DESCRIPTION OF THE DRAWINGS

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a schematic diagram of an embodiment of a monitoring system of the present disclosure.

FIG. 2 is a block diagram of the monitoring system of FIG. 1.

FIG. 3 is a circuit diagram of the monitoring system of FIG. 1.

FIG. 4 is a circuit diagram of another embodiment of the monitoring system of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

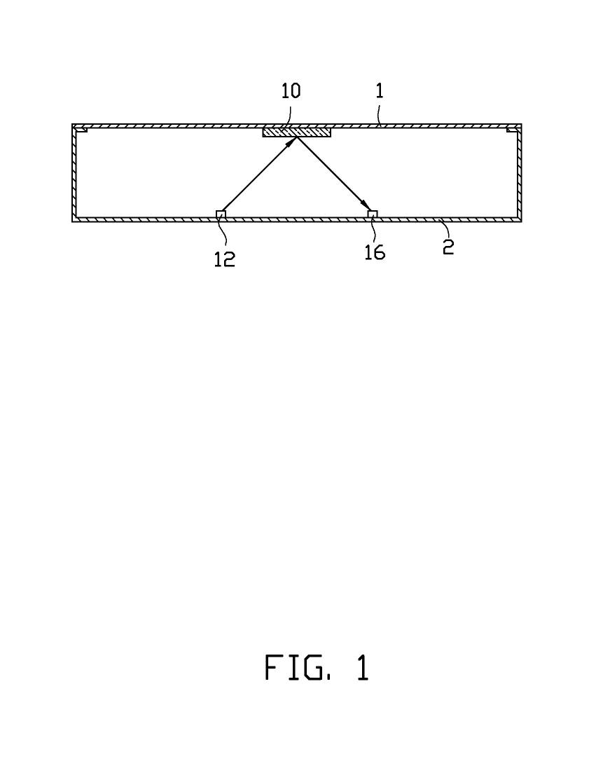

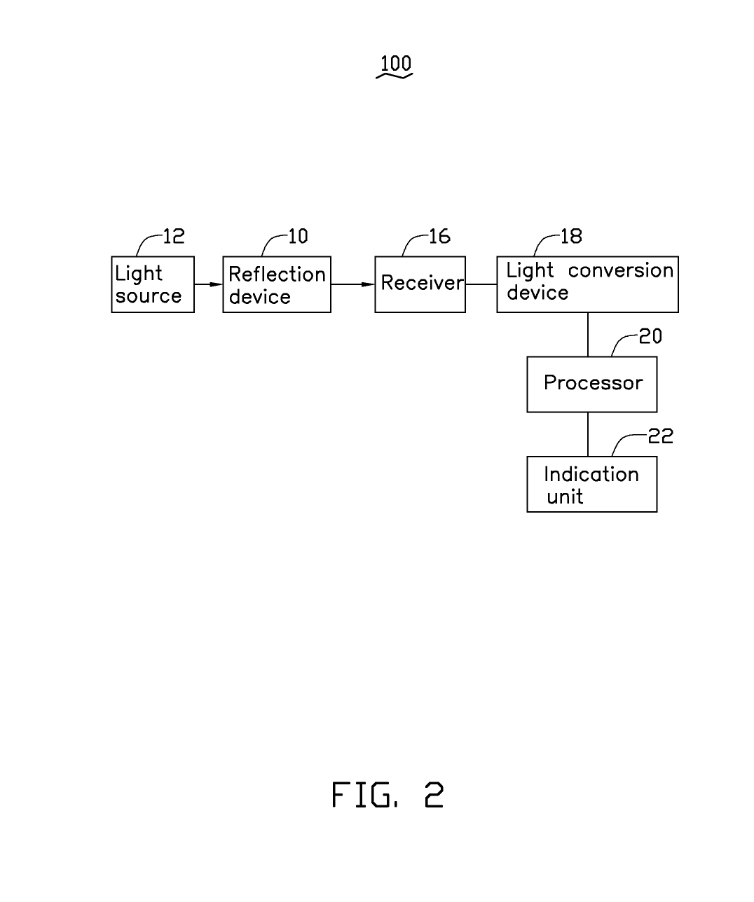

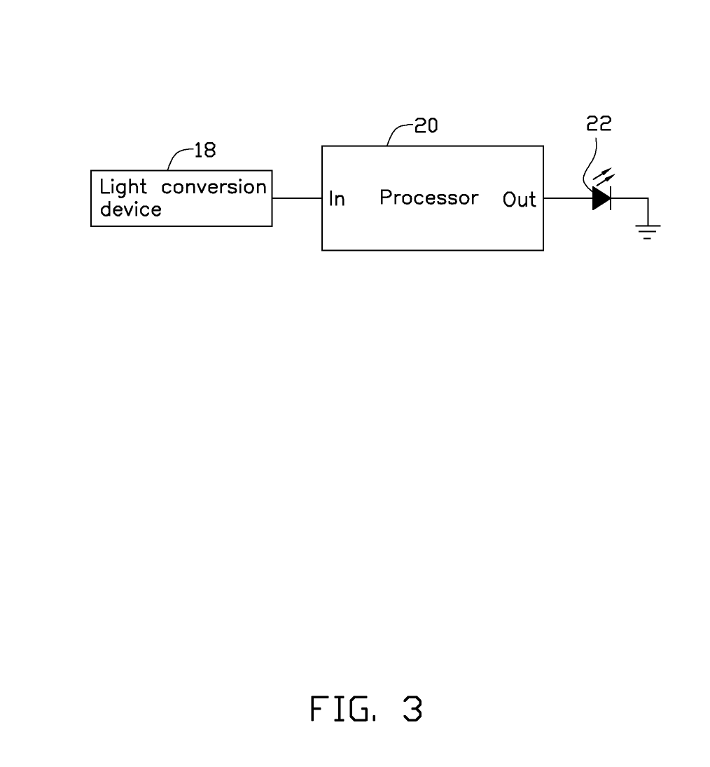

FIGS. 1-3 show an embodiment of a monitoring system 100.

The monitoring system 100 is used to monitor an open and closed state of a case of an electronic device, such as a server. The case includes a shell 2 and a cover 1 detachably mounted on the shell 2. A motherboard (not shown) and other chips (not shown), such as central processing units, are located inside the shell 2. The cover 1 covers the shell 2 to shield the motherboard and the other chips.

The monitoring system 100 includes a reflection device 10, a light source 12, a receiver 16, a light conversion device 18, a processor 20, and an indication unit 22. The reflection device 10 is located on an inner surface of the cover 1 and faces an interior of the shell 2. The light source 12 and the receiver 16 are located on a surface of the shell 2 facing the reflection device 10. When the cover 1 covers the shell 2, light emitted from the light source 12 reaches the reflection device 10 and is reflected to the receiver 16. In one embodiment, the light source 12 and the receiver 16 are located on the motherboard, and the reflection device 10 is a mirror.

The receiver 16 is electrically connected to the light conversion device 18. The light conversion device 18 is used to convert light received by the receiver 16 into electrical signals. The light conversion device 18 is connected to the processor 20.

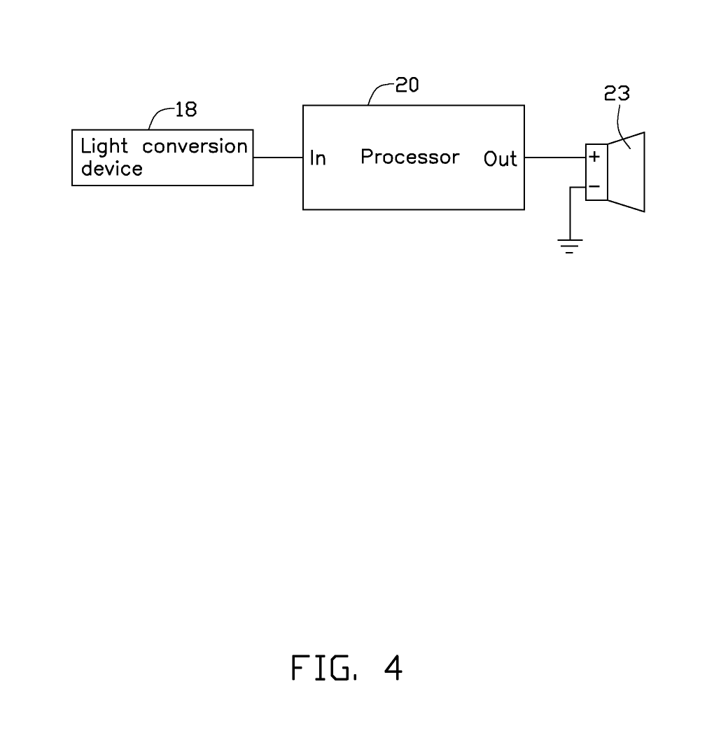

When the cover 1 is open, light emitted from the light source 12 cannot reach the reflection device 10, so the processor 20 cannot receive electrical signals from the light conversion device 18. The processor 20 outputs a control signal to the indication unit 22, and the indication unit 22 operates to indicate that the cover 1 is open. The processor 20 records a first time when the light conversion device 18 stops outputting electrical signals, and a second time when the light conversion device 18 starts to output electrical signals. In one embodiment, the indication unit 22 is a light-emitting diode (LED). An anode of the LED is connected to an output pin Out of the processor 20. A cathode of the LED is grounded. In one embodiment, the processor 20 is a base management controller connected to the light conversion device 18 through an input pin In to receive electrical signals. When the processor 20 is not receiving electrical signals from the light conversion device 18, the processor 20 outputs a high-level signal, such as logic 1, to the anode of the LED through the output pin Out. Thus, the LED is lit up to indicate that the cover 1 is open. In another embodiment, the indication unit 22 is a buzzer 23 (see FIG. 4). A positive terminal of the buzzer 23 is connected to the output pin of the processor 20. A negative terminal of the buzzer 23 is grounded. The processor 20 can be a central processing unit.

Positions of the reflection device 10, the light source 12, and the receiver 16 can be changed as long as when the cover 1 covers the shell 2, light emitted from the light source 12 can reach the reflection device 10, and light reflected by the reflection device 10 can reach the receiver 16, and when the cover 1 is open, light emitted from the light source 12 cannot reach the reflection device 10, and light reflected by the reflection device 10 cannot reach the receiver 16. In one embodiment, the reflection device 10 is located on the motherboard, and the light source 12 and the receiver 16 are located on the cover 1.

While the disclosure has been described by way of various embodiments, it is to be understood that the disclosure is not limited thereto. To the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A monitoring system arranged in a case which comprises a shell and a cover detachably covered on the shell, the monitoring system comprising:
a reflection device;
a light source;
a receiver to receive light emitted from the light source and reflected from the reflection device when the cover covers the shell;
a light conversion device connected to the receiver to convert light received by the receiver into electrical signals;
a processor to receive the electrical signals from the light conversion device and output a control signal when not receiving the electrical signals; and
an indication unit connected to the processor to indicate that the cover is open when receiving the control signal, wherein the reflection device is arranged on one of the shell and the cover, and the light source and the receiver are arranged on the other one of the shell and the cover.

2. The monitoring system of claim 1, wherein the processor records a first time when the light conversion device stops outputting the electrical signals and a second time when the light conversion device starts to output electrical signals.

3. The monitoring system of claim 1, wherein the reflection device is located on an inner surface of the cover, and the light source and the receiver are located in the shell.

4. The monitoring system of claim 1, wherein the reflection device is located in the shell, and the light source and the receiver are located on an inner surface of the cover.

5. The monitoring system of claim 1, wherein the indication unit is a light emitting diode (LED), an anode of the LED is connected to an output pin of the processor, a cathode of the LED is grounded, wherein the control signal is a high voltage level signal.

6. The monitoring system of claim 1, wherein the reflection device is a mirror.

7. The monitoring system of claim 1, wherein the indicating device is a buzzer, wherein a positive terminal of the buzzer is connected to an output pin of the processor, and a negative terminal of the buzzer is grounded.
